(19) United States
(12) Patent Application Publication
(10) Pub. No.: US 2015/0228040 A1
(43) Pub. Date: Aug. 13, 2015

(54) Health Care Provider Entity Location Selection & Market Capacity Model

(71) Applicant: Patrick Joseph Charland, Cary, NC (US)

(72) Inventor: Patrick Joseph Charland, Cary, NC (US)

(21) Appl. No.: 14/176,179

(22) Filed: Feb. 10, 2014

(51) Int. Cl. G06Q 50/22; G06Q 10/06

(52) U.S. Cl. CPC G06Q 50/22; G06Q 10/063

(57) ABSTRACT

An early stage market research and site selection method for health care entities, which identifies areas of provider saturation and opportunity within a defined population. This novel method employs a technique to evaluate an entire state, and each division therein, whereby financial models are used with population based visit estimates to achieve a 5-year net present value for a potential investment in a health care provider entity with a defined mix of services. This thus, allows for a profitability comparison between potential areas and clinic configurations to determine which options are most likely to achieve long term success, or a positive five year return on invested capital.

### CROSS REFERENCE TO RELATED APPLICATIONS

Not Applicable.

### STATEMENT REGARDING FEDERALLY SPONSORED RESEARCH OR DEVELOPMENT

Not Applicable.

Reference to Sequence Listing, a Table, or a Computer Program Listing Compact Disk Appendix:

Not Applicable.

### BACKGROUND OF THE INVENTION

The invented method pertains to the field of site selection for health care provider entities. Using health care utilization metrics with capital budgeting analysis, the method prioritizes locations to develop health care provider entities. For a given state, this method will identify areas of saturation and opportunity for providers of a defined mix of health care services, such as urgicenters. This aims to reduce considerable health care spending related to misappropriated capital.

No other approaches exist which are this comprehensive and broad in scope. The current site selection approaches do not include a method incorporating visit estimates with capital budgeting analysis for a comprehensive comparative evaluation of each market within a state. The more narrow approaches do not quantify and compare risk associated with entering each market. Therefore, they are not as likely to meet a state's health care demands in the most cost effective manner.

### REFERENCES

1. Burt, Catherine and Esther Hing. Making patient-level estimates from medical encounter records using a multiplicity estimator. Statist. Med. 2007; 26: 1762-1774. DOI:10.1002/sim.2797.
2. U.S. Department of Health and Human Services. National Health Statistics Reports: “National Ambulatory Medical Care Survey (1992-2010).” Center for Disease Control and Prevention, National Center for Health Statistics. Web. Retrieved from: http://www.cdc.gov/nchs/ahcd/ahcd_reports.html 2011-2013.
3. Dietrich, Mark. BVR's Guide to Physician Practice Valuation. United States of America: Sarah Anderson, 2012. Print.
4. Borglum, Keith. Medical Practice Valuation Appraisal Guidelines & Workbook. United States of America: PSR Publications, 2011. Print.
5. Dietrich, Mark and Gregory Anderson. The Financial Professionals Guide to Health Care Reform. Hoboken, N.J.: John Wiley & Sons, Inc., 2012. Print.
6. American Fact Finder. U.S. Department of Commerce. 2010 U.S. Census Bureau. North Carolina Census. Web. Retrieved from: http://factfinder2.census.gov/faces/nav/jsf/pages/community facts.xhtml 2010-2013.
7. Annual Managed Care Data Filing. Jul. 31, 2013. NCGS 58-3-191, Market Regulation Division. NC Department of Insurance. Web. Retrieved from: http://www.ncdoi.com/MR/MR_MC_Annual.aspx 2013.
8. NC Division of Medical Assistance. “North Carolina Medicaid CCNC/CA Monthly Enrollment Report.” NC Department of Health and Human Services, January 2013. Web. Retrieved from: http://www.ncdhhs.gov/dma/ca/enroll/2013.
9. FY2013 Income Limits. Effective Dec. 11, 2012. U.S. Department of Housing and Urban Development. Median Household Income per County. Web. Retrieved from: http://www.huduser.org/portal/datasets/il.html 2013.
10. Health Care Development Consulting, L.L.C. (2013). North Carolina Urgent Care Market Report© 2013. Web. Retrieved from: http://www.consultingurgentcare.com 2013.
11. Licensed Facilities. July 2013. North Carolina Department of Health and Human Services, Division of Health Services Regulation. Web. Retrieved from: http://www.ncdhhs.gov/dhsr/reports.html 2013.
12. Robert Wood Johnson Foundation. “County Health Rankings & Road Maps.” A Healthier Nation County by County, 2013. Web. Retrieved from: http://www.countyhealthrankings.org/ 2013.

### BRIEF SUMMARY OF THE INVENTION

The method prioritizes locations and configurations in which to develop health care entities. The process relies upon health care utilization metrics provided by the Center for Disease Control describing number of visits per 100 people. These metrics are then applied to defined population, for example, the 100 individual counties of North Carolina. Each county will produce a number of visits to health care provider entities of a defined service mix relative to its population. Total annual visits are determined for each county. These visits are divided amongst current providers, and the number of daily visits is determined.

Operational benchmark data for health care provider entities (e.g. urgicenters) are obtained, such as average reimbursement per visit, and hourly rate for employees, initial capital, and all other data necessary to create a realistic financial model for the provider entity. This is set up in a Microsoft Excel spreadsheet. Three models are established to represent provider facilities (with a set mix of services) requiring low, medium, and high amounts of initial capital. For example, a clinic operating in leased space versus a stand-alone clinic built new. Cash flows are forecasted out 5 years using the appropriate growth rates and a standardized net income capitalization rate to achieve a 5 year net present value (NPV) for the investment

Data for each county are applied to the standardized financial models to determine NPV estimates for each. Counties with a negative NPV are either too saturated with urgicenters to operate profitably, or do not have the population to adequately sustain them without subsidy, significant cost sharing, large patient networks, or some other unusual reimbursement agreement for the urgicenter mix of services. Counties with positive NPV either represent profitable operations, or the opportunity for a successful operation.

Further analysis can be applied to counties showing a positive NPV by adding to the number of existing clinics to determine the additional clinic capacity. The number of urgicenters that can be added until a negative NPV is achieved represents the potential number of additional urgicenters the county can sustain.

By applying this method across each state to identify areas of saturation and opportunity for urgicenters, millions of dollars in misappropriated capital can be saved. Further, areas requiring subsidy to meet underserved populations can be identified, and plans can be developed accordingly in advance.

### BRIEF DESCRIPTION OF THE SEVERAL VIEWS OF THE DRAWING

Not Applicable.

### DETAILED DESCRIPTION OF THE INVENTION

The method in the following description will be applied to urgicenters in North Carolina and its 100 counties for the purpose of illustration. It can be applied to any health care provider entity with a defined mix of services. In the following, a brief introduction is provided followed by a detailed description of how to make the models, how to apply the method, and how to interpret the results.

Requirements: Microsoft Excel Software. NAMCS Reports 1992-2010 (source for population based health care utilization metrics). Most recent US Census data (example below uses population data for all 100 North Carolina counties). Clinic Operational Benchmark Metrics (example provided below uses urgicenter data). Current listing of clinics in state of focus (example uses urgent care clinics in North Carolina).

The method for determining market saturation and opportunity for site selection of health care provider entities, in this example urgicenters, begins with the daily visit estimates for each county in North Carolina.

These estimates can be used to simulate operations over five years, using financial models to determine a 5-year net present value for an investment in an urgicenter. Net present value (NPV), a term seen in corporate finance with regard to capital budgeting, represents a way to evaluate a potential investment by assessing the return on initial capital over five years. A positive value represents a profitable venture, and a negative value does not.

Once the daily visits for each county have been applied to the simulation models, a net present value is determined for each county with each model. The financial models must use a standard set of operational benchmark metrics and a net income capitalization rate so that each county can be evaluated as a potential urgicenter host in a standardized manner.

This method employs three models: 1, 2A, and 2B. Model 1 is the least capital intensive, representing operations in a leased space, while 2A and 2B represent operations in a stand-alone facility. Model 2A is constructed on less expensive real estate using less expensive materials than Model 2B. The three models allow the market to be assessed not only for profitability with the least amount of capital (Model 1) but also for high and low capital intensive configurations (Model 2B and 2A).

A positive NPV for Model 1 in a county with no current urgicenter providers suggests that the county has the potential to profitably sustain one in that configuration. If the result is a negative NPV for Model 1, then the market is either too saturated with urgicenters or does not have sufficient population to sustain one profitably without subsidy, significant cost sharing, large patient networks, or any unusual reimbursement for the defined scope of services in any model configuration.

This information can help investors in many ways. First, it identifies areas that are not likely to be profitable, thereby preventing the misallocation of capital and reducing unnecessary health care costs tremendously. In kind, it identifies areas that would require subsidy to meet health care needs of underserved populations and estimates the amount of subsidy required.

### How to Make:

A description of how to make and use the models within Microsoft Excel is provided in the following four sections. Section 1, describes the methods for Visit Estimation. Section 2, describes the appropriate set of operational assumptions required to build the models. Section 3, describes how the models are constructed using the operational assumptions data. Section 4, describes how the models can be used to evaluate the market for saturation and opportunity and prioritize capital investments accordingly.

### Section 1: Visit Estimation.

The tables in the following sections contain column and row labels as they would in Excel. These have been added for ease of demonstration and replication.

The first step involves estimating annual visits. The number of physician office visits per population has been collected and reported by the CDC in NAMCS reports since 1992. They currently list number of visits per 100 people per year. The percentage of these which are urgicenter visits is reported annually, thus allowing for an estimation of these visits for a population.

The model requires estimation of visits for the current year and forecasted visits for four additional years. The following example illustrates how this process is performed using the Microsoft Excel (Microsoft Corporation, Redmond, Wash., USA) program. First, the average growth rate per year must be determined from the NAMCS data in the table below by setting M2 equal to the following equation.

=(((L2−A2)/(AVERAGE(A2:L2)))/(2010−1999))

| | A | B | C | D | E | F | G | H | I | J | K | L | M |
|---|---|---|---|---|---|---|---|---|---|---|---|---|---|
| 1 | 1999 | 2000 | 2001 | 2002 | 2003 | 2004 | 2005 | 2006 | 2007 | 2008 | 2009 | 2010 | GR |
| 2 | 278.5 | 300.4 | 314.4 | 314.4 | 317.3 | 315.9 | 331.0 | 306.6 | 335.6 | 320.1 | 344.1 | 332.2 | 1.54% |

Next, visits can be forecasted. Start by typing the value from L2 into A5, and set B5 equal to the formula below. Drag this across the years to be forecasted B5-I5.

=(A5*$M2)+A

| | A | B | C | D | E | F | G | H | I |
|---|---|---|---|---|---|---|---|---|---|
| 4 | 2010 | 2011 | 2012 | 2013 | 2014 | 2015 | 2016 | 2017 | 2018 |
| 5 | 332 | 337 | 342 | 348 | 353 | 359 | 364 | 370 | 375 |

Once the number of physician office visits per 100 people has been estimated for the desired years, the data can be applied to a population. For the purposes of this example, it will be done for all 100 counties in North Carolina. This requires population data for the present year or most recent year for each county. For the purposes of this example, the equation for estimating visits for one county is shown below.

### Alamance County 2013 Population:

| | A | B |
|---|---|---|
| 7 | County | Population |
| 8 | Alamance | 153033 |

Number of physician office visits for 2014-2018 is achieved using the visit metrics in the table above along with the current population for Alamance County, N.C. with the following formula starting in A11 and dragged to E11. The table below displays the resulting physician office visits estimates for Alamance County in years 2014-2018.

=($B$8/100)*E5

| | A | B | C | D | E |
|---|---|---|---|---|---|
| 10 | 2014 | 2015 | 2016 | 2017 | 2018 |
| 11 | 540367 | 548674 | 557109 | 565674 | 574371 |

Next, is the estimation of urgicenter visits per day for each year. This requires the NAMCS data which reports the percentage of physician office visits that went to urgicenters. This data is entered for years available (1997-2010) as seen in the table below.

| | A | B | C | D | E | F | G | H | I | J | K | L | M | N |
|---|---|---|---|---|---|---|---|---|---|---|---|---|---|---|
| 14 | 1997 | 1998 | 1999 | 2000 | 2001 | 2002 | 2003 | 2004 | 2005 | 2006 | 2007 | 2008 | 2009 | 2010 |
| 15 | 6.3% | 4.9% | 3.1% | 5.4% | 7.8% | 5.2% | 7.4% | 4.3% | 5.5% | 7.8% | 6.3% | 3.1% | 3.5% | 4.3% |

The average over this period must be determined to forecast urgicenter visits. It is obtained using the following formula:

=AVERAGE(A15:N15)

=5.35%

The number of daily visits to urgicenters in Alamance County for years 2014-2018 is determined using the following formula:

=(5.35%*A11)/365

This yields the following daily visit values, when applied to each year:

| | A | B | C | D | E |
|---|---|---|---|---|---|
| 18 | 2014 | 2015 | 2016 | 2017 | 2018 |
| 19 | 79.20 | 80.42 | 81.66 | 82.91 | 84.19 |

Once visit estimates for each county have been determined, the number of visits per urgicenter in each county can be determined. To accomplish this, you must have an up to date database listing the urgicenters operating in each county. For the purposes of this example, Alamance County will be used which currently has 3 in operation. Therefore, the average number of visits per day for each year will be divided by 3 to achieve the average number of visits per day to each urgicenter as seen in the table below. These values will be used later in the financial models to determine market saturation and opportunity.

| | A | B | C | D | E |
|---|---|---|---|---|---|
| 22 | 2014 | 2015 | 2016 | 2017 | 2018 |
| 23 | 26.40 | 26.81 | 27.22 | 27.64 | 28.06 |

### Section 2: Operational Assumptions.

This section describes a standardized set of urgicenter operational assumptions. The operational metrics must be obtained from current benchmark reports and databases. They must be entered into the Excel spreadsheet so that the data can be used by the financial models in calculating net present value estimates. A detailed description for each is shown below:

### Revenue Assumptions:

| | A | B | C | D | E |
|---|---|---|---|---|---|
| 25 | Revenue per | Percent | Charge | Percent of | Average |
| | visit: | of | | accounts | reimbursement |
| | | visits | | receivable | per visit |
| | | | | collected | |
| 26 | General visit | 100% | $95 | 85% | 2013 |
| 27 | Workers Comp | 15% | $115 | 85% | $123 |
| 28 | Office/Lab | 15% | $35 | 85% | |
| 29 | Procedure | 20% | $65 | 85% | |
| 30 | Outsourced | 10% | $30 | 85% | |
| | Lab/Test | | | | |
| 31 | X-Ray | 15% | $35 | 85% | |
| 32 | Drugs & Rx | 20% | $30 | 85% | |

The table above represents the average type of visits, their typical distribution, charge, percent collected, and the resulting average reimbursement per visit. The models assume that each urgicenter is opening new. Therefore, a visit ramp up (a gradual increase in visits) is included for the first six months as the “local population” becomes increasingly aware that the urgicenter is open.

### Visit Ramp-Up Table:

| | A | B | C |
|---|---|---|---|
| 35 | Month 1 | .45% of total daily visit estimates | =.45*A23 |
| 36 | Month 2 | .45% of total daily visit estimates | =.45*A23 |
| 37 | Month 3 | .70% of total daily visit estimates | =.7*A23 |
| 38 | Month 4 | .85% of total daily visit estimates | =.85*A23 |
| 39 | Month 5 | .90% of total daily visit estimates | =.9*A23 |
| 40 | Month 6 | 100% of total daily visit estimates | =A23 |

The equations in column C, rows 35-40 represent the Excel formulas to determine average daily visits for each month of the ramp up period during the first six months.

### Forecasting Average Reimbursement Per Visit:

The annual average reimbursement growth rate is 2%. This must be used to obtain average reimbursement per visit for each year 2014-2018. This table will be sourced later for use in the model. The formulas required are displayed in the cells below:

| | A | B |
|---|---|---|
| 45 | Reimbursement Growth rate | 102% |

### Urgicenter Hours of Operation Assumptions:

| | A | B | C | D |
|---|---|---|---|---|
| 55 | Days | Hours | Total Annual | Average hours |
| | | | Hours | per month |
| 56 | M-F | 60 | 3120 | |
| 57 | Sat | 8 | 416 | |
| 58 | Sun | 8 | 416 | |
| 59 | Total | 76 | 3952 | 329.33 |

### Office Layout Assumptions:

Office Lay out (3600 sq. ft.)

1 waiting room
1 front office
1 administrative office
1 business office
1 billing office/marketing office
1 waste management room
1 x-ray room*
1 lab/nurses station
4 treatment rooms: 1 procedure room, 3 exam rooms
1 restroom
1 physicians lounge
1 storage room

### Staffing Assumptions:

Employees Required

| | |
|---|---|
| 4-7 | Full and Part time physicians |
| 4 | Full time and 4 part time M/A's |
| 2 | Part time MA/x-ray techs* |

### Labor Calculations—Inclusive of Benefits and Insurance for Fiscal Year 2013:

### Physician:

| | A | B |
|---|---|---|
| 65 | | Physician Full Time |
| 66 | Salary | $170,000.00 |
| 67 | Malpractice | $25,000.00 |
| 68 | Tail | $3,000.00 |
| 69 | Health | $6,250.00 |
| 70 | Workers Comp | $1,250.00 |
| 71 | Salary with benefits | $205,500.00 |

### Medical Assistant (M): Nurse Practitioner (NP), Physician Assistant (PA):

| | A | B |
|---|---|---|
| 75 | | Medical Assistant |
| 76 | Salary | $75,000.00 |
| 77 | Health | $6,250.00 |
| 78 | Workers Comp | $1,250.00 |
| 79 | Salary with benefits | $82,500.00 |

### Administrator:

| | A | B |
|---|---|---|
| 85 | | Administrative Assistant Full Time |
| 86 | Salary | $35,000.00 |
| 87 | Health | $6,250.00 |
| 88 | Workers Comp | $1,250.00 |
| 89 | Salary with benefits | $42,500.00 |

### X-Ray and Laboratory Technician:

| | A | B |
|---|---|---|
| 95 | | X-ray and Laboratory Tech |
| 96 | Part Time Salary | $32,750.00 |
| 97 | Workers Comp | $1,250.00 |
| 98 | Salary with benefit | $34,000.00 |

### Staffing Hourly Cost Determinations:

The annual salary and benefit data above must be divided by 2000 hours to determine the hourly cost per employee. These values will be forecasted using an annual growth rate of 2.5% for later use in the models. The Excel formulas to calculate these values have been transcribed in the appropriate cells of the corresponding tables below. These cells will be sourced in the models.

### Staffing Compensation Growth Rate:

| | A | B |
|---|---|---|
| 102 | Value for calculating staff income growth: | 102.50% |

| | A | B | C | D | E | F |
|---|---|---|---|---|---|---|
| 105 | Physician | 2014 | 2015 | 2016 | 2017 | 2018 |
| 106 | Salary and Benefits | =B102*B71 | =B102*B106 | =B102*C106 | =B102*0106 | =B102*E106 |
| 107 | Per Hour | =B106/2000 | =C106/2000 | =D106/2000 | =E106/2000 | =F106/2000 |
| 110 | NP or PA | 2014 | 2015 | 2016 | 2017 | 2018 |
| 111 | Salary and Benefits | =B102*B79 | =B102*B111 | =B102*C111 | =B102*D111 | =B102*E111 |
| 112 | Per Hour | =B111/2000 | =C111/2000 | =D111/2000 | =E111/2000 | =F111/2000 |
| 115 | Administrator | 2014 | 2015 | 2016 | 2017 | 2018 |
| 116 | Salary and Benefits | =B102*B89 | =B102*B116 | =B102*C116 | =B102*D116 | =B102*E116 |
| 117 | Per Hour | =B116/2000 | =C116/2000 | =D116/2000 | =E116/2000 | =F116/2000 |
| 120 | X-ray & Lab Tech | 2014 | 2015 | 2016 | 2017 | 2018 |
| 121 | Salary and Benefits | =B102*B98 | =B102*B121 | =B102*C121 | =B102*D121 | =B102*E121 |
| 122 | Per Hour | =B121/2000 | =C121/2000 | =D121/2000 | =E121/2000 | =F121/2000 |

### Staffing Model Assumptions:

Given the models assume each urgicenter opens on the first day of simulation, the staffing protocol requires that a physician be present during all hours of operation for the first four months. Otherwise, when visits are below 25 per day, only an MA is present with an x-ray/lab tech and an administrator. When visits range between 25 and 35 visits per day a physician is present as well. When daily visits exceed 35, an additional MA is staffed. When visits exceed 60 per day, an additional physician is staffed. Following these commands, the simulations will automatically adjust to the most efficient and cost effective staffing configuration for each county. Finally, when visits are <25 per day the reimbursement per visit is 85% of average, because no physician will be present in those circumstances after the first four months. The formulas used in the models to execute these commands are described in Section 3.

### Initial Capital Assumptions:

Each model differs with regard to initial capital. The initial capital costs for models 1, 2A, and 2B are described below.

### Initial Capital Costs for Model 1:

| Publications/Periodicals/Organizations | |
|---|---|
| AMA | $450.00 |
| OCMA | $450.00 |
| UCAOA | $500.00 |
| CONTRCTING/CREDENTIALING | |
| LICENSES, DEA, AND SL- FOR MEDICAL | $900.00 |
| DIRECTOR ONLY | |
| Printing | |
| RX PADS, SUPERBILLS, STATIONARY AND MISC. | $2,500.00 |
| SET-UP COSTS | |
| COMPUTERS | |
| 5-6 COMPUTERS - 1 server, 4-5 networked computers | $6,800.00 |
| Printer/fax/copiers X 1 | $1,700.00 |
| Additional Printer/fax x 3 | $680.00 |
| EMR-Practice Velocity | $6,800.00 |
| Tech Support and Setup | $1,600.00 |
| Equipment for 1 trauma room and 3 exam rooms | |
| Digital Machine | $72,500.00 |
| Radiology | $4,650.00 |
| Slit Lamp X 1 | $1,020.00 |
| Autoclave X 1 | $3,725.00 |
| EKG Machine X 1 | $4,250.00 |
| Exam Tables X 4 | $10,200.00 |
| Medical Stools X 4 | $510.00 |
| Microscope X 1 | $595.00 |
| Overhead Surgical Light X 1 | $2,295.00 |
| Welch Allyn Integrated X 4 | $5,780.00 |
| Trauma Room Supply Cabinet | $3,145.00 |
| Free Standing Drawer Cabinet X 4 | $22,100.00 |
| Surgical Supplies misc. | $8,500.00 |
| Pharmaceuticals set up (In house sales) | $2,975.00 |
| Refrigerators X 3, 2 in lab, 1 break room | $2,550.00 |
| Furnishings | |
| Misc. Furnishings | $10,200.00 |
| File cabinets | $4,250.00 |
| Start-up Capital | $181,625.00 |

### Initial Capital Costs for Model 2A:

| Publications/Periodicals/Organizations | |
|---|---|
| AMA | $450.00 |
| OCMA | $450.00 |
| UCAOA | $500.00 |
| CONTRCTING/CREDENTIALING | |
| LICENSES, DEA, AND SL- FOR MEDICAL | $900.00 |
| DIRECTOR ONLY | |
| Printing | |
| RX PADS, SUPERBILLS, STATIONARY AND MISC. | $2,500.00 |
| SET-UP COSTS | |
| COMPUTERS | |
| 5-6 COMPUTERS - 1 server, 4-5 networked computers | $6,800.00 |
| Printer/fax/copiers X 1 | $1,700.00 |
| Additional Printer/fax x 3 | $680.00 |
| EMR-Practice Velocity | $6,800.00 |
| Tech Support and Setup | $1,600.00 |
| Equipment for 1 trauma room and 3 exam rooms | |
| Digital Machine | $72,500.00 |
| Radiology | $4,650.00 |
| Slit Lamp X 1 | $1,020.00 |
| Autoclave X 1 | $3,725.00 |
| EKG Machine X 1 | $4,250.00 |
| Exam Tables X 4 | $10,200.00 |
| Medical Stools X 4 | $510.00 |
| Microscope X 1 | $595.00 |
| Overhead Surgical Light X 1 | $2,295.00 |
| Welch Allyn Integrated X 4 | $5,780.00 |
| Trauma Room Supply Cabinet | $3,145.00 |
| Free Standing Drawer Cabinet X 4 | $22,100.00 |
| Surgical Supplies misc. | $8,500.00 |
| Pharmaceuticals set up (In house sales) | $2,975.00 |
| Refrigerators X 3, 2 in lab, 1 break room | $2,550.00 |
| Furnishings | |
| Misc. Furnishings | $10,200.00 |
| File cabinets | $4,250.00 |
| Building | |
| 3140 sq.ft. @ $120/sf New Building | $376,800.00 |
| (Parking lot, other contract work to site) | $80,000.00 |
| Signage | $2,500.00 |
| Land 1 acre real estate | $159,055.00 |
| Start-up Capital | $800,000.00 |

### Initial Capital Costs for Model 2B:

| Publications/Periodicals/Organizations | |
|---|---|
| AMA | $500.00 |
| OCMA | $500.00 |
| UCAOA | $500.00 |
| Licenses, DEA. | $900.00 |
| Printing | |
| Rx Pads, bills, stationary and misc. set-up costs | $3,000.00 |
| Computers | |
| 5-6 Computers - 1 server, 4-5 networked computers | $8,000.00 |
| Printer/fax/copiers X 1 | $2,000.00 |
| Additional Printer/fax x 3 | $800.00 |
| EMR-Practice Velocity | $8,000.00 |
| Tech support and set-up | $2,000.00 |
| Equipment for 1 trauma room and 3 exam rooms | |
| Digital X-ray machine | $85,000.00 |
| Radiology | $5,000.00 |
| Slit Lamp X 1 | $1,200.00 |
| Autoclave X 1 | $4,500.00 |
| EKG Machine X 1 | $5,000.00 |
| Exam Tables X 4 | $12,000.00 |
| Medical Stools X4 | $600.00 |
| Microscope X1 | $700.00 |
| Overhead Surgical Light X 1 | $2,700.00 |
| Welch Allyn Integrated X 4 | $6,800.00 |
| Trauma room supply cabinet | $3,700.00 |
| Free standing drawer cabinet X 4 | $26,000.00 |
| Surgical supplies misc. | $10,000.00 |
| Pharmaceuticals set up (In house sales) | $3,500.00 |
| Refrigerators x 3: 2 in lab, 1 break room | $3,000.00 |
| Furnishings | |
| Misc. Furnishings | $12,000.00 |
| TV's & audio | $5,000.00 |
| File cabinets | $5,000.00 |
| Building | |
| 3140 sq.ft. @ $120/sf New Building | $376,800.00 |
| (assumes lot free) | |
| Parking lot, other contract work to site | $120,000.00 |
| Signage | $2,500.00 |
| Land 1 acre prime real estate | $783,700.00 |
| Start-up Capital | $1,500,000.00 |

### Models 1, 2A, and 2B Initial Capital Reference Table:

| | A | B |
|---|---|---|
| 125 | Model | Initial Capital Requirement |
| 126 | 1 | $181,625.00 |
| 127 | 2A | $800,000.00 |
| 128 | 2B | $1,500,000.00 |

### Operating Expense Calculations:

Operating expense calculations will vary with respect to each model. For example, Model 1 requires a monthly rent expense, while Models 2A and 2B do not. The tables below list the operational expenses for their respective models. When not specifically stated, operational costs are assumed equal for each model.

### Marketing Expenses:

| | A | B |
|---|---|---|
| 130 | Annual Budget | $20,000.00 |
| 131 | Total | $20,000.00 |
| 132 | Per Hour of Operation | $5.06 |

### Utilities Expense Estimate:

| | A | B | C | D |
|---|---|---|---|---|
| 135 | | Model 1 | Model 2A | Model 2B |
| 136 | Square Feet | 3,140 | 3,140 | 3,140 |
| 137 | Annual Rate | $13 | | |
| 138 | Annual Rent | $40,800.00 | | |
| 139 | Utility | $14,280.00 | $14,280.00 | $14,280.00 |
| | Expense | | | |
| | @ 35% | | | |
| 140 | Monthly rent | $3,400.00 | | |
| 141 | Per hour rent | $10.32 | | |
| | expense | | | |
| 142 | Total Utility | $14,280.00 | $14,280.00 | $14,280.00 |
| | Expense | | | |
| 143 | Per Hour of | $3.61 | $3.61 | $3.61 |
| | Operation | | | |

### Depreciation:

| | A | B | C | D |
|---|---|---|---|---|
| 145 | | Model 1 | Model 2A | Model 2B |
| 146 | Building | | $376,800.00 | $376,800.00 |
| | Cost | | | |
| 147 | Equipment | $144,245.00 | $144,245.00 | $169,700.00 |
| 148 | Computers | $23,800.00 | $23,800.00 | $20,800.00 |
| 149 | Furnishings | $13,600.00 | $13,600.00 | $27,000.00 |
| 150 | Building | 39 years | 39 years | 39 years |
| | Depreciation | | | |
| | (commercial | | | |
| | property) | | | |
| 151 | Other | 6 years | 6 years | 6 years |
| | Depreciation | | | |
| 152 | Total | $30,274.17 | $39,935.71 | $45,078.21 |
| 153 | Per Hour of | $7.66 | $10.27 | $11.41 |
| | Operation | | | |

### Other Expenses:

| | A | B |
|---|---|---|
| 155 | Med Supplies | $20,000.00 |
| 156 | Lab Costs | $10,000.00 |
| 157 | Communications | $2,000.00 |
| 158 | Office Products | $3,000.00 |
| 159 | Accounting/Legal | $10,000.00 |
| 160 | Other Expenses | $5,000.00 |
| 161 | Equipment Lease | $12,000.00 |
| 162 | Office Insurance | $2,000.00 |
| 163 | Total | $64,000.00 |
| 164 | Per Hour of Operation | $16.19 |

### Operational Expense Growth Rate Table:

Growth in annual expenses must be accounted for. The Following table contains the expense growth rates which will be used.

| | A | B |
|---|---|---|
| 165 | Rent Increase Multiplier | 101.5% |
| 166 | Utilities Expense growth | 100.5% |
| 167 | Expenses Growth Multiplier | 101.5% |

### Section 3: How to Make Simulation Models in Excel.

Each of the tables, values, and rates described in the sections above should be in the same Excel workbook so that they can be sourced for use in the cash flow tables for each model.

### How to Make Model 1:

### Monthly Operational Cash Flow Tables:

| | A | B | C | D | E |
|---|---|---|---|---|---|
| 170 | Month | January 2014 | February 2014 | March 2014 | April 2014 |

In the row above, list months January through December, each in a separate Column, and repeat for each forecasted year 2014-2018.

| | A | B | C | D | E |
|---|---|---|---|---|---|
| 171 | Days | 31 | 29 | 31 | 30 |

In the next row, as seen above, list the number of days that correspond with month above it in the same Column.

| | A | B | C | D | E | F | G |
|---|---|---|---|---|---|---|---|
| 172 | Visits per day | =C35 | =C36 | =C37 | =C38 | =C39 | =C40 |

In the row above, the visits per day will be sourced from the visit ramp up table for the first six months of operations.

The months remaining in 2014 displayed in the table below, will source the table containing the average visits per day for each year. As with N172 in the table below (in the January 2015 column) each cell in this row will reference the appropriate corresponding average daily visit number for its respective year.

| | H | I | J | K | L |
|---|---|---|---|---|---|
| 172 | =A23 | =B23 | =C23 | =D23 | =E23 |

The next row represents the visits per month as seen in the table below. It is equal to the visits per day times the number of days for the corresponding month.

| | A | B | C | D |
|---|---|---|---|---|
| 173 | Visits per month | =B171*B172 | =C171*C172 | =D171*D172 |

### Revenue Per Visit Section:

The next seven rows are used to determine the revenue per visit.

| | A | B | C | D |
|---|---|---|---|---|
| 175 | General visit | =$D26*G26 | =B175 | =B175 |
| 176 | Workers Comp | =B27*C27*D27 | =B176 | =B176 |
| 177 | Office/Lab | =B28*C28*D28 | =B177 | =B177 |
| 178 | Procedure | =B29*C29*D29 | =B178 | =B178 |
| 179 | Outsourced | =B30*C30*D30 | =B179 | =B179 |
| | Lab/Test | | | |
| 180 | X-Ray | =B31*C31*D31 | =B180 | =B180 |
| 181 | Drugs & Rx | =B32*C32*D32 | =B181 | =B181 |

The first active column (column B) sources the reimbursement assumptions table. The remaining months in the year will have equal values. When a new year is reached, the annual reimbursement growth rate will be multiplied to the corresponding cell in the last month of the previous year. This step is illustrated in columns N and O of the table below which represent the columns for January 2015 and February 2015 respectively.

| | A | B | C | M | N | O |
|---|---|---|---|---|---|---|
| 175 | General visit | =$D26*G26 | =B175 | =B175 | =M175*B45 | =N175 |
| 176 | Workers Comp | =B27*C27*D27 | =B176 | =B176 | =M176*B45 | =N176 |
| 177 | Office/Lab | =B28*C28*D28 | =B177 | =B177 | =M177*B45 | =N177 |
| 178 | Procedure | =B29*C29*D29 | =B178 | =B178 | =M178*B45 | =N178 |
| 179 | Outsourced | =B30*C30*D30 | =B179 | =B179 | =M179*B45 | =N179 |
| | Lab/Test | | | | | |
| 180 | X-Ray | =B31*C31*D31 | =B180 | =B180 | =M180*B45 | =N180 |
| 181 | Drugs & Rx | =B32*C32*D32 | =B181 | =B181 | =M181*B45 | =N181 |

The revenue per visit section contains one more row. A unique feature regarding the equations used in this row must be explained. The final row represents the revenue per visit. For the first four months, this simply equals the sum of rows 175-181 for each column. However, when visits are less than 25 per day, after the first four months, a physician is no longer present and the reimbursement per visit is reduced to 85% of total average reimbursement per visit. The table below illustrates the equations necessary to incorporate this phenomenon into the model.

| | A | B | F |
|---|---|---|---|
| 182 | Reimbursement per visit | =sum(B175:B181) | =IF(F172<25,(SUM(F175:F181))*0.85,(SUM(F175:L181))) |

### Monthly Gross Revenue:

The next eight active rows are used to calculate the monthly gross revenue. The table below illustrates the equations required. The equations from Column B can be dragged across to December 2018.

| | A | B | C |
|---|---|---|---|
| 185 | General visit | =B$173*B175 | =C$173*C175 |
| 186 | Workers Comp | =B$173*B176 | =C$173*C176 |
| 187 | Office/Lab | =B$173*B177 | =C$173*C177 |
| 188 | Procedure | =B$173*B178 | =C$173*C178 |
| 189 | Outsourced | =B$173*B179 | =C$173*C179 |
| | Lab/Test | | |
| 190 | X-Ray | =B$173*B180 | =C$173*C180 |
| 191 | Drugs & Rx | =B$173*B181 | =C$173*C181 |
| 192 | Gross Revenue | =B$173*B182 | =C$173*C182 |
| | per month | | |

### Expense Tables:

The following tables will describe the set up and equations necessary to include expenses in the models. The following tables will include labor, marketing, rental (for model1), and miscellaneous expenses.

As previously described, the staffing model accounts for an annual 2.5% raise for staff, and adjusts automatically to the average number of daily visits per month. In kind, the labor expense calculations must account for this. It must also account for the requirement that a physician be present during the first four months regardless of daily visits. The following tables explain how this is accomplished.

| | A | B |
|---|---|---|
| 195 | Physicians | =$B$107*(($B$56+$B$57+$B$58)/7)*B$171 |

The equation in B195 represents hourly cost of physician labor multiplied by the average hours per day times the number of days in that month (Column B: January: 31 days). This equation calculates physician labor costs for the first four months. Thereafter, the model determines physician presence based on the visits and determines cost accordingly.

The equation in the table below must be used to account for this staffing variation. Starting after the fourth month, it will be dragged across the spreadsheet to the December 2014. Each new year must source the new hourly rate: for 2015, $B$107, in the equation below, will be replaced with $C$107, etc.

| | A | F |
|---|---|---|
| 195 | Physcians | =IF(F$172>25,$B$107*(($B$56+$B$57+$B$58)/7)*F$171, |
| | | ((($B$67+$B$68+$B$69+$B$70)/$C$59)*$D$59)) |

The next row accounts for the cost associated with having an additional physician staffed when visits exceed 60 per day. The table below illustrates the equations required to accomplish this. It can be dragged across all months.

| | A | B |
|---|---|---|
| 196 | Physicians | =IF(B172>60,B195,0) |

The next row accounts for the cost of a medical assistant. It is simply the hourly rate times the number of hours per day times the number of days per month. This is seen in the table below. This equation can be dragged across each month of the year. With each new year, the hourly rate must be reassigned; $B$112 will be replaced with $C$112 for the 2015 months, and $D$112 will be used for the 2016 months, etc.

| | A | B |
|---|---|---|
| 197 | Medical Assistants | =$B$112*(($B$56+$B$57+$B$58)/7)*B171 |

When visits per day are greater than 35, an additional medical assistant is added. This is accounted for in the next row as displayed in the table below.

| | A | B |
|---|---|---|
| 198 | Additional MA | =IF(B172>35,B197,0) |

The next row accounts for the cost for administrative staff. It is the hourly rate times the number of hours per day times the number of days for the respective month. Each new year must use the new hourly rate. For the months in 2015, $B$117 in the table below will be replaced with $C$117, and so on for each year.

| | A | B |
|---|---|---|
| 199 | Administrative Staff | =$B$117*(($B$56+$B$57+$B$58)/7)*B171 |

Row 200 in the table below, will represent costs associated with X-ray and lab technician staff. It is the hourly rate times the number of hours per day times the number of days for the respective month. Each new year must employ a new hourly rate. For the months in 2015, $B$122 in the table below will be replaced with $C$122, and so on for each year.

| | A | B |
|---|---|---|
| 200 | Technician Staff | =$B$122*(($B$56+$B$57+$B$58)/7)*B171 |

The next row accounts for the advertising and marketing expense. It is determined using an hourly rate multiplied by the number of hours per day times the number of days per month. This is illustrated in the table below. The equation can be dragged across all months.

| | A | B |
|---|---|---|
| 201 | Marketing Expenses | =$B$132*(($B$56+$B$57+$B$58)/7)*B171 |

The next expense to consider for Model 1 is the monthly rent. This value is sourced from the table previously described as seen in the table below.

| | A | B |
|---|---|---|
| 202 | Rental Expense | =$B$140 |

The rental expense increases 1.5% each year. When a new year is reached, the annual rental expense growth rate will be multiplied to the corresponding cell in the last month of the previous year. This step is illustrated in columns M, N, and O of the table below which represent the columns for December 2014, January 2015, and February 2015 respectively.

| | A | B | C | M | N | O |
|---|---|---|---|---|---|---|
| 202 | Rental Expense | =$B$140 | =B202 | =L202 | =M202*B165 | =N202 |

Utilities expense will be addressed next. This value is sourced from the table previously described, and is seen in the table below. The utilities expense increases 0.5% each year. When a new year is reached, the annual utilities growth rate will be multiplied to the corresponding cell in the last month of the previous year. This step is illustrated in columns M, N, and O of the table below which represent the columns for December 2014, January 2015, and February 2015 respectively.

| | A | B | C | M | N | O |
|---|---|---|---|---|---|---|
| 203 | Utilities Expense | =$B$139/12 | =B203 | =L203 | =M203*B166 | =N203 |

The next eight rows are treated in a similar fashion. They each represent different cost categories and are subject to an annual expense growth rate. The table below displays these cost categories and the equations required to calculate them.

| | A | B | C | M | N | O |
|---|---|---|---|---|---|---|
| 204 | Med Supplies | =$B$155/12 | =B204 | =L204 | =M204*B167 | =N204 |
| 205 | Lab costs | =$B$156/12 | =B205 | =L205 | =M205*B167 | =N205 |
| 206 | Communications | =$B$157/12 | =B206 | =L206 | =M206*B167 | =N206 |
| 207 | Office Products | =$B$158/12 | =B207 | =L207 | =M207*B167 | =N207 |
| 208 | Accounting/Legal | =$B$159/12 | =B208 | =L208 | =M208*B167 | =N208 |
| 209 | Other Expenses | =$B$160/12 | =B209 | =L209 | =M209*B167 | =N209 |
| 210 | Equipment Lease | =$B$161/12 | =B210 | =L210 | =M210*B167 | =N210 |
| 211 | Office Insurance | =$B$162/12 | =B211 | =L211 | =M211*B167 | =N211 |

Total monthly expenses will be summed in the next row. The table below illustrates the formulas required. The equation can be dragged across every month until December 2018.

| | A | B | C |
|---|---|---|---|
| 212 | Total Monthly | =sum(B195:B211) | =sum(C195:C211) |
| | Expenses | | |

Depreciation will be calculated next using the hourly depreciation cost multiplied by the number of hours per day times the number of days per month. The equation can be dragged across every month until December 2018.

| | A | B |
|---|---|---|
| 213 | Depreciation | =$B$153*(($B$56+$B$57+$B$58)/7)*B171 |

The next row is used to determine the earnings before income tax. This value is gross monthly revenue−total monthly expenses−depreciation. It is illustrated in the table below. The equation can be dragged across every month until December 2018.

| | A | B |
|---|---|---|
| 214 | Earnings Before Income Tax | =B192−B212−B213 |

Finally, initial capital expenditure is included in the cash flows section. It is sources from the table described earlier and is only listed in the first month of operations as seen in the table below.

| | A | B |
|---|---|---|
| 215 | Initial Capital Expenditure | =B126 |

Simulation Models 2A and 2B will have a very similar cash flow tables. The only differences will be an absence of rental expense, a different depreciation cost, and a different initial capital expenditure. Their respective values will be sourced from the same tables. They are further described later in this Section.

### Summary Income Table:

This next table is required to obtain a 5 year net present value estimate. It will be comprised of a summary of annual revenues, expenses, depreciation, earnings before income tax, income tax, initial capital expenditure, and a 5 year net present value of all cash flows. The tables below illustrate the set up and equations required for the annual revenue calculations.

| | A | B | C | D |
|---|---|---|---|---|
| 220 | Revenue Table | FY1 | FY2 | FY3 |
| 221 | General visit | =sum(B185:M185) | =sum(N185:Y185) | =sum(Z185:AK185) |
| 222 | Workers Comp | =sum(B186:M186) | =sum(N186:Y186) | =sum(Z186:AK186) |
| 223 | Office/Lab | =sum(B187:M187) | =sum(N187:Y187) | =sum(Z187:AK187) |
| 224 | Procedure | =sum(B188:M188) | =sum(N188:Y188) | =sum(Z188:AK188) |
| 225 | Outsourced lab | =sum(B189:M189) | =sum(N189:Y189) | =sum(Z189:AK189) |
| 226 | X-Ray | =sum(B190:M190) | =sum(N190:Y190) | =sum(Z190:AK190) |
| 227 | Drugs & Rx | =sum(B191:M191) | =sum(N191:Y191) | =sum(Z191:AK191) |
| 228 | Gross Revenue | =sum(B192:M192) | =sum(N192:Y192) | =sum(Z192:AK192) |

| | A | E | F |
|---|---|---|---|
| 220 | Revenue Table | FY4 | FY5 |
| 221 | General visit | =sum(AL185:AW185) | =sum(AX185:BI185) |
| 222 | Workers Comp | =sum(AL186:AW186) | =sum(AX186:BI186) |
| 223 | Office/Lab | =sum(AL187:AW187) | =sum(AX187:BI187) |
| 224 | Procedure | =sum(AL188:AW188) | =sum(AX188:BI188) |
| 225 | Outsourced lab | =sum(AL189:AW189) | =sum(AX189:BI189) |
| 226 | X-Ray | =sum(AL190:AW190) | =sum(AX190:BI190) |
| 227 | Drugs & Rx | =sum(AL191:AW191) | =sum(AX191:BI191) |
| 228 | Gross Revenue | =sum(AL192:AW192) | =sum(AX192:BI192) |

The following two tables illustrate the set up and equations required for the annual expense calculations; the first for years 1-3, and the second for years 4-5.

| | A | B | C | D |
|---|---|---|---|---|
| 230 | Expense Table | FY1 | FY2 | FY3 |
| 231 | Physicians | =sum(B195:M195) | =sum(N195:Y195) | =sum(Z195:AK195) |
| 232 | Additional MD | =sum(B196:M196) | =sum(N196:Y196) | =sum(Z196:AK196) |
| 233 | MA | =sum(B197:M197) | =sum(N197:Y197) | =sum(Z197:AK197) |
| 234 | Additional MA | =sum(B198:M198) | =sum(N198:Y198) | =sum(Z198:AK198) |
| 235 | Administrative | =sum(B199:M199) | =sum(N199:Y199) | =sum(Z199:AK199) |
| 236 | Tech | =sum(B200:M200) | =sum(N200:Y200) | =sum(Z200:AK200) |
| 237 | Marketing | =sum(B201:M201) | =sum(N201:Y201) | =sum(Z201:AK201) |
| 238 | Rent | =sum(B202:M202) | =sum(N202:Y202) | =sum(Z202:AK202) |
| 239 | Utilities | =sum(B203:M203) | =sum(N203:Y203) | =sum(Z203:AK203) |
| 240 | Med supplies | =sum(B204:M204) | =sum(N204:Y204) | =sum(Z204:AK204) |
| 241 | Lab costs | =sum(B205:M205) | =sum(N205:Y205) | =sum(Z205:AK205) |
| 242 | Communications | =sum(B206:M206) | =sum(N206:Y206) | =sum(Z206:AK206) |
| 243 | Office products | =sum(B207:M207) | =sum(N207:Y207) | =sum(Z207:AK207) |
| 244 | Accounting/Legal | =sum(B208:M208) | =sum(N208:Y208) | =sum(Z208:AK208) |
| 245 | Other Expense | =sum(B209:M209) | =sum(N209:Y209) | =sum(Z209:AK209) |
| 246 | Equipment | =sum(B210:M210) | =sum(N210:Y210) | =sum(Z210:AK210) |
| 247 | Office Insurance | =sum(B211:M211) | =sum(N211:Y211) | =sum(Z211:AK211) |
| 248 | Total Expenses | =sum(B231:B247) | =sum(C231:C247) | =sum(D231:D247) |
| 249 | | | | |
| 250 | Depreciation | =sum(B213:M213) | =sum(N213:Y213) | =sum(Z213:AK213) |

| | A | E | F |
|---|---|---|---|
| 230 | Expense Table | FY4 | FY5 |
| 231 | Physicians | =sum(AL195:AW195) | =sum(AX195:BI195) |
| 232 | Additional MD | =sum(AL196:AW196) | =sum(AX196:BI196) |
| 233 | MA | =sum(AL197:AW197) | =sum(AX197:BI197) |
| 234 | Additional MA | =sum(AL188:AW198) | =sum(AX198:BI198) |
| 235 | Administrative | =sum(AL199:AW199) | =sum(AX199:BI199) |
| 236 | Tech | =sum(AL200:AW200) | =sum(AX200:BI200) |
| 237 | Marketing | =sum(AL201:AW201) | =sum(AX201:BI201) |
| 238 | Rent | =sum(AL202:AW202) | =sum(AX202:BI202) |
| 239 | Utilities | =sum(AL203:AW203) | =sum(AX203:BI203) |
| 240 | Med supplies | =sum(AL204:AW204) | =sum(AX204:BI204) |
| 241 | Lab costs | =sum(AL205:AW205) | =sum(AX205:BI205) |
| 242 | Communications | =sum(AL206:AW206) | =sum(AX206:BI206) |
| 243 | Office products | =sum(AL207:AW207) | =sum(AX207:BI207) |
| 244 | Accounting/Legal | =sum(AL208:AW208) | =sum(AX208:BI208) |
| 245 | Other Expense | =sum(AL209:AW209) | =sum(AX209:BI209) |
| 246 | Equipment | =sum(AL210:AW210) | =sum(AX210:BI210) |
| 247 | Office Insurance | =sum(AL211:AW211) | =sum(AX211:BI211) |
| 248 | Total Expenses | =sum(E231:E247) | =sum(F231:F247) |
| 249 | | | |
| 250 | Depreciation | =sum(AL213:AW213) | =sum(AX213:BI213) |

Annual earnings before income tax must be determined next. The equation in B251, will be dragged across to Column F.

| | A | B | C | D |
|---|---|---|---|---|
| 251 | EBIT | =B228−B248−B250 | =C228−C248−C250 | =D228−D248−D250 |

A corporate tax rate schedule allows for the simulation models to automatically calculate the appropriate tax according to EBIT. The equations required for this are illustrated in the table below for year one. To create a complete table, equations will be dragged to year five for each row in Column 1 (1250-1257).

| | H | I |
|---|---|---|
| 248 | Corporate Tax Reference Table | |
| 249 | ($) | YR 1 |
| 250 | EBIT<50000 | =0.15*B248 |
| 251 | EBIT>50000<75000 | =7500+((0.25*(B248−50000))) |
| 252 | EBIT>75000<100000 | =13750+((0.34*(B248−75000))) |
| 253 | EBIT>100000<335000 | =(22250+((0.39*(B248−100000)))) |
| 254 | EBIT>335000<10000000 | =(113900+(0.34*(B248−335000))) |
| 255 | EBIT>10000000<15000000 | =(3400000+(0.35*(B248−10000000))) |
| 256 | EBIT>15000000<18333333 | =(5150000+(0.38*(B248−15000000))) |
| 257 | EBIT>18333333 | =(0.35*6248) |

The table above will be sourced to calculate the taxes listed in the income summary table. The equations required are displayed in the table below. The EBIT for each year will fall within a range that will determine the tax for that year. The equation below allows the correct row in the Corporate Tax Reference Table above to be sourced. The equation listed below for year 1 will be dragged across to year five (Column F).

| | A | B |
|---|---|---|
| 252 | Tax | =IF(B251<50000,I250,IF(B251<75000,I251,IF(B251<100000,I252,IF(B251<335000,I253, |
| | | IF(B251<10000000,I254<15000000,I255,IF(B251<18000000,I256,I257))))))) |

Earnings after tax is next on the income summary table. The equation required for this value listed B253 can be dragged across to Column F.

| | A | B | C | D |
|---|---|---|---|---|
| 253 | Earnings after | =B251−B252 | =C251−C252 | =D251−D252 |
| | tax | | | |

The next row will source values described above for initial capital expenditure in year one and in years 3 and 5 a capital allocation of $10,000 has been incorporated into the model for maintenance and enhancement. The table below illustrates how this is set up.

| | | | | | |
|---|---|---|---|---|---|
| A | B | C | D | E | F |

| | | | | |
|---|---|---|---|---|
| 254 | Capital | =B126 | $10000.00 | $10000.00 |

Finally, net income can be determined for each year. This will then be used to determine the 5 year net present value. Cell B255 in the table below lists the equation required, which can be dragged across to Column F

| | A | B | C | D |
|---|---|---|---|---|
| 255 | Net Income | =B253−B254−B250 | =C253−C254−C250 | =D253−D254−D250 |

The 5-year net present value equation requires a Net Income Capitalization Rate. The Build-up Method was used to determine a rate of 27.9%. This method is displayed below.

Cap rate: Use Build up method

| | | | |
|---|---|---|---|
| | Risk free rate | | 3.68 |
| + | Equity Risk Premium | | 6.18 |
| − | Average Market return | | 9.86 |
| + | Small Company Risk Premium | | 6.5 |
| − | Average Market return, small public shares | | 16.36 |
| + | Adjust for size versus public shares | 5 | |
| + | % Medicare and PPO payment reductions | 4 | |
| + | % HMO contracts in place | 1 | |
| + | Management Depth & Experience | 2 | |
| − | Multiple Owners & Associates | −1 | |
| + | Dominant Competitor | 2.5 | |
| − | Corporate Practice Prohibition state | 0 | |
| + | Subtotal Subject Company Risk Adjustments | | 13.5 |
| = | Net Cash Flow Discount Rate | | 29.86 |
| − | Long Term Sustainable Growth Rate | | 2 |
| = | Net Income Capitalization Rate | | 27.86 |

The table below displays the equation required to calculate the 5 Year Net Present Value for an investment in Model 1.

| | A | B |
|---|---|---|
| 256 | 5 Year Net Present Value | =NPV(.279,B255,F255) |

### How to Make Models 2A and 2B:

After following the steps above to make Model 1, save it; then use the “save as” function in Excel to save a copies of Model 1 under the name Model 2A and Model 2B. It will be easier to make adjustments to Model 1 to create Models 2A and 2B. Note these will be separate files. The following section will describe the changes required to develop Model 2A from Model 1 and Model 2B from Model 1. Recall the major differences between Model 1 and Models 2A and 2B are in initial capital, rent expense, and depreciation.

Open file Model 2A, initial capital can be adjusted to fit Model 2A by setting cell B254 in the Income Summary Table equal to B127. Likewise, cell B215, in the cash flow table, will be set equal to B127.

The hourly rate for depreciation will need to source that of Model 2A. This is accomplished by replacing “$B$153” with “$C$153” in the formula listed in cell B213. This new formula will need to be dragged across to Column BI, the December 2018 Column.

Rent Expense will be adjusted to complete Model 2A by deleting row 202 from the cash flow summary table. You will also need to delete row 238 from the Income Summary Table. The other cells will adjust accordingly. Finally, Click save, your model 2A is complete.

Next, open file Model 2B, initial capital can be adjusted to fit Model 2B by setting cell B254 in the Income Summary Table equal to B128. Likewise, cell B215, in the cash flow table, will be set equal to B128.

The hourly rate for depreciation will need to source that of Model 2B. This is accomplished by replacing “$B$153” with “$D$153” in the formula listed in cell B213. This new formula will need to be dragged across to Column BI, or the December 2018 Column.

Rent Expense will be adjusted to complete Model 2B by deleting row 202 from the cash flow summary table. You will also need to delete row 238 from the Income Summary Table. The other cells will adjust accordingly. Finally, Click save, your model 2B is complete.

### Section 4: How to Use the Simulation Models to Evaluate Market Saturation.

In the Model 1 file, open a new sheet. Starting in the third row of Column A, list all 100 counties in North Carolina. In the next Column, list the corresponding populations.

Next, starting in Column C, Row 2, begin listing years 2014-2018. Below this you will project the physician office visits for each county and each year. The tables below illustrate the set up and formulas required for this operation.

| | A | B | C | D | E | F | G |
|---|---|---|---|---|---|---|---|
| 1 | | | Physician Office Visit Projections | | | | |
| 2 | County | Population | 2014 | 2015 | 2016 | 2017 | 2018 |
| 3 | Alamance | 153033 | 540367 | 548674 | 557109 | 565674 | 574371 |

| | A | B | C |
|---|---|---|---|
| 2 | County | Population | 2014 |
| 3 | Alamance | 153033 | =($B3/100)*‘Sheet1’!E$5 |

The equation for physician office visits from Section 1 is displayed in cell C3 of the above table. This equation can be dragged across to Column G to forecast the remaining years. Additionally, you may drag the equation down to the final row in each Column C-G. This will give you physician office visits for every county in years 2014-2018.

Once these values are obtained, urgicenter visits may be forecasted, starting in Column H. Sheet 1 must be referenced for the percentage of physician office visits that are to urgicenters (5.35%). Multiply 0.0535 by the corresponding physician office visits for each county and year. The table below illustrates this task. This equation can be dragged across to Column L and down every row for each county to determine the number of annual urgicenter visits to each county.

| | H |
|---|---|
| 2 | 2014 |
| 3 | =(C3*5.35%) |

Next, starting in row three of Column M, begin listing the number of current urgicenter providers in each corresponding county. Once this is accomplished, you can begin running simulations for Model 1. It is recommended that this sheet be copied so that “values” can be pasted to Sheet 2 of Models 2A and 2B. Once this is completed, you can begin running simulations for all models.

### How to Run Simulations:

The same technique will be used in each model. The net present value results are compared side by side for each county. To determine 5 year net present values for urgicenters operating in each county you will have to set the cells in the visits table of Sheet1, A23-E23, equal to the number of urgicenter visits from Sheet 2, H3/365-L3/365 to get daily visits for years 2014-2018. This will give a net present value for each county in ‘Sheet1’?B256 to be copied and listed in a table. The resulting table will look like the following:

| | Current | | | |
|---|---|---|---|---|
| County | Clinics | NPV Model 1 | NPV Model 2A | NPV Model 2B |
| Alamance | 3 | $109,006.90 | ($181,274.26) | ($787,941.78) |
| Alexander | 0 | $120,444.11 | ($133,474.16) | ($740,300.64) |
| Alleghany | 0 | ($1,090,482.57) | ($1,310,624.35) | ($1,924,464.43) |
| Anson | 0 | ($299,448.85) | ($558,591.73) | ($1,167,100.75) |
| Ashe | 0 | ($266,756.00) | ($531,716.16) | ($1,140,225.19) |
| Avery | 0 | ($747,858.66) | ($968,000.44) | ($1,581,840.51) |
| Beaufort | 0 | $107,307.46 | ($186,539.35) | ($792,837.11) |
| Bertie | 0 | ($597,381.60) | ($817,523.38) | ($1,431,363.45) |
| Bladen | 0 | $54,285.43 | ($219,100.14) | ($826,508.53) |
| Brunswick | 2 | $292,679.24 | $9,057.04 | ($597,769.43) |
| Buncombe | 5 | $31,846.03 | ($255,243.74) | ($861,152.48) |
| Burke | 1 | $1,346,122.41 | $1,060,517.23 | $453,108.84 |
| Cabarrus | 6 | ($126,690.06) | ($399,009.72) | ($1,007,518.74) |
| Caldwell | 2 | $301,644.08 | $18,091.14 | ($588,735.33) |
| Camden | 0 | ($1,138,683.84) | ($1,358,825.62) | ($1,972,665.69) |
| Carteret | 3 | ($498,650.02) | ($721,556.15) | ($1,333,656.41) |
| Caswell | 0 | ($456,119.49) | ($684,346.90) | ($1,294,850.29) |
| Catawba | 4 | $203,583.14 | ($76,560.12) | ($683,386.59) |
| Chatham | 1 | $488,433.39 | $204,417.07 | ($402,991.32) |
| Cherokee | 0 | ($258,009.46) | ($663,522.62) | ($1,132,764.21) |

### Interpreting the Results:

The table above lists the 5-year net present values (NPV) from the simulation results for the first 20 counties. Certain counties stand out as being saturated or unable to support an urgicenter profitably without subsidy or unusual circumstances. Alleghany County for example, has a highly negative NPV and no current urgicenters. Therefore, it does not have the population to sustain a profitable urgicenter. Cabarrus County has a negative NPV in all models, indicating that it is currently saturated with urgicenters, and some are likely losing money. Beaufort County has a positive NPV in Model 1 but not Model 2A. Therefore, it has the population required to profitably support an urgicenter with the Model 1 configuration but not a Model 2A or 2B. Burke County on the other hand, has a positive NPV for each model. This represents a county with potential for growth in the urgicenter market with respect to even the highly capital intensive models.

All counties with positive NPV results under the current number of clinics should be assessed further for growth with up to four additional clinics. This is done in a similar manner to that described above, but the visits are divided by n−1, n+2, n+3, and n+4 where n is the current number of urgicenters. New simulations are run with the new number of visits and the results are copied and pasted into a comparative table as seen in the table below listing the results of two counties for Model 1.

| Net Income Capitalization Rate: | | | | | | |
|---|---|---|---|---|---|---|
| 27.9% | | | | | | |
| | Current | | 5-Yr Net Present Value With Additional Clinics | | | |
| County | Clinics | NPV Model 1 | 1+ | 2+ | 3+ | 4+ |
| Alamance | 3 | $109,006.90 | $179,758.86 | ($127,802.52) | ($357,463.85) | ($541,947.25) |
| Alexander | 0 | $120,444.11 | $120,444.11 | ($717,345.12) | ($1,027,845.96) | ($1,183,096.39) |

Both counties appear able to sustain an additional low capital model within their respective markets. Note that Alamance County has a higher NPV with four clinics than its current number of three. This situation arises when an additional clinic causes the number of visits per day to each clinic to fall less than 25. In this case, a physician is no longer present. This reduces staffing expenses and creates more profitable points of access to care with in the county.

I claim:

1. A model in a computer system for determining the areas within a state which are most and least likely to provide a positive five year net present value (NPV) on an investment in a health care provider entity (e.g. urgent care clinic). In which, said model makes use of: population derived health care utilization metrics (specific to a service mix of interest) to create daily visit estimates which are divided by the number of current providers (sharing the same service mix, e.g. urgent care clinics) within said areas (e.g. counties) and forecasted five years, which when used in combination with operational benchmark metrics in developing high fidelity financial models of low, medium, and high capital requiring configurations, allow for the determination of net present values of said potential investments.

2. The method of claim 1 which includes an assumption of average reimbursement collected per visit based on metrics from current benchmark surveys of current providers of said service mix regarding a typical distribution of service requests per visit, typical charges for providing said requests per visit, and percentage of claims collected.

3. The method of claim 1 which includes a subdivision of a state into areas with defined populations (e.g. counties).

4. The method in claim 2 which includes an identification of all current health care provider entities of similar service mix within said defined areas.

5. The method of claim 1 which includes annual growth rates in said high fidelity financial models for said average reimbursement per visit, employee salary, rent expense (in low capital requiring configuration only), utilities expense, and operational expenses to obtain forecasts of revenues and expenses over five years.

6. The method of claim 1 which includes use of annual calculations of depreciation in said high fidelity financial models.

7. The method of claim 1 which includes use of annual calculations of earnings before income tax in said high fidelity financial models.

8. The method of claim 1 which includes use of annual calculations of corporate tax in said high fidelity financial models.

9. The method in claim 1 which includes determination of a net income capitalization rate using the Build-up Method in said high fidelity financial models.

10. The method in claim 1 which makes use of said net income capitalization rate to determine net present values of annual cash flows in said high fidelity financial models.

11. The method in claim 1 which includes a step of ranking said net present values of all subdivided areas within the state, for each said financial model of low medium and high capital requiring configurations, from most positive NPV to most negative NPV thereby allowing for prioritization and planning of capital allocation within the state based on profit potential and/or subsidy requirements.
